(19) United States
(12) Patent Application Publication
(10) Pub. No.: US 2007/0125180 A1
(43) Pub. Date: Jun. 7, 2007

(54) METHOD FOR DETERMINING A STRAIN PROPERTY OF A WEB

(76) Inventors: Rudolf Munch, Konigsbronn (DE); Volker Scholzke, Krefeld (DE)

Correspondence Address: TAYLOR & AUST, P.C., 142 SOUTH MAIN STREET, P. O. BOX 560, AVILLA, IN, 46710, US

(21) Appl. No.: 11/567,422

(22) Filed: Dec. 6, 2006

(30) Foreign Application Priority Data
Dec. 6, 2005 (DE) DE102005058142.0

(51) Int. Cl. G01L 1/00

(52) U.S. Cl. 73/760

(57) ABSTRACT

The present invention relates to a method for determining at least one strain property of a web running on a machine for the production of a fibrous web, said method including the following steps: conveying the web via at least two consecutive driven rollers, wherein the web between consecutive driven rollers is unsupported respectively at least in sections; determining the tensile force in the web between the consecutive rollers; determining the differential speed of the consecutive rollers in relation to each other; and, determining the at least one strain property of the web conveyed between the driven rollers with account taken of the at least one differential speed and the at least one tensile force.

### BACKGROUND OF THE INVENTION

1. Field of the Invention

This invention relates to a method for determining at least one strain property of a web running on a machine for the production of a fibrous web. The web can be a fibrous web, and it can also be a paper machine covering.

2. Description of the Related Art

Using the methods known from the prior art it is possible to determine strain properties such as elasticity or strength properties such as bursting strength, elongation at break or tensile strength only offline, meaning in the laboratory after taking a sample or else by way of special sensors such as ultrasonic sensors for example.

Offline measurement has in addition the disadvantage of not being able to react directly during production to fluctuations of the web elasticity and web strength beyond the tolerance range, which can lead to considerable waste production because of the time delay thus caused.

Both options, taking measurements in the laboratory and using special instruments, are very costly in this connection.

Similarly, the measurement of strain properties of machine coverings—this can be helpful in predicting the remaining life of the covering for example—often requires special apparatuses with which the remaining life can be deduced from the mesh tension.

What is needed in the art is a method of the type initially referred to, with which the described disadvantages no longer arise.

### SUMMARY OF THE INVENTION

The present invention provides a method for determining at least one strain property of a web running on a machine for the production of a fibrous web, said method having the following steps: the web is conveyed via at least two consecutive driven rollers, wherein the web between consecutive driven rollers is unsupported respectively at least in sections; furthermore, provision is made for the tensile force of the web between the consecutive rollers to be determined along with the differential speed of the consecutive rollers in relation to each other; also, the at least one strain property of the web conveyed between the driven rollers is determined with account taken of the at least one differential speed and the at least one tensile stress.

The method of the invention is based on the idea of determining strain properties of the web, meaning a fibrous web or a machine covering, on the basis of variables which on machines for producing a fibrous web are already determined and controlled as controlled variables or parameters for the production of the fibrous web. Hence with the method of the invention it is possible, in order to determine strain properties of the web, to make use of systems already existing on today's machines for producing a fibrous web.

Because the differential speed between the driven rollers is a yardstick for the strain of the web, it is possible with the method of the invention to calculate, in accordance with Hooke's law, the elastic modulus from the known tensile force, which is why the strain property of the web can be its elastic modulus. Using the method of the invention it is thus possible to determine the elastic modulus directly.

Because both the tensile force in the web and the differential speed are usually determined continuously during the production process, it is possible in addition for the strain property to be determined continuously throughout the process, thus enabling unwanted changes during production to be corrected.

The time-related change of the tensile force and/or the time-related change of the differential speed are taken into account in order to determine the at least one strain property.

Machines for producing a fibrous web are usually speed-controlled, i.e. a constant differential speed is established between consecutive driven rollers and only the tensile force acting on the web is controlled such that the predefined differential speed remains constant. Hence in this case, in order to determine a different strain property of the web in the web running direction, the time-related change of the respective tensile force is calculated and the differential speed between the consecutive rollers is held constant over time.

Unlike previously described, for example in the winding up area, the web draw of the winding roller is held constant and the differential speed between the winding roller and the previously driven roller is controlled in order to establish the constant web draw. In this case, in order to determine a different strain property of the web in the web running direction, the time-related change of the respective differential speed is calculated and the tensile force of the web between the respectively consecutive rollers is held constant over time.

The present invention is not limited to a fibrous web such as in particular a paper web, paperboard web or tissue web; rather it is to apply likewise to a covering, in particular a forming mesh, a press felt, a dryer fabric or a smooth transfer belt.

On today's machines for producing a fibrous web, the drive torques of the driven rollers are controlled continuously and their actual states recorded. Using the drive torques it is also possible to influence the tensile force in the web; hence a preferred further aspect of the invention provides for the tensile force of the web to be calculated with account taken of the respective drive torques of the roller drives, wherein the drive torques are calculated from a knowledge of the values of the drive parameters of the roller drives, in particular the electric voltage, the electric current or the power input.

The calculation of the tensile force also draws on key data of the gear units of the roller drives and/or key data of the rollers such as in particular the frictional resistance of the bearing arrangement of the roller, the roller diameter and the like. It is thus possible on the basis of the values of the drive parameters to determine the tensile force of the web with great reliability.

Often slipping occurs between the driven rollers and the web conveyed thereon. To increase the accuracy of the value of the calculated strain property, another embodiment of the present invention provides for values of the friction between the web and the driven rollers to be taken into account for determining the at least one strain property.

In this case it is even possible for an absolute value of the at least one strain property to be determined.

Of course it is possible to arrange, between the driven rollers, one or more non-driven rollers via which the web is conveyed. The non-driven rollers can be guide rollers or deflecting rollers for example.

Also it is possible to arrange, between the driven rollers, a known blast box with a curved blast face via which the web is conveyed. Hence it is possible to produce, between the curved blast face of the blast box and the web, an air cushion which strains the web conveyed between the driven rollers. From the calculable strain of the web, the radius of curvature of the blast box and the pressure for producing the air cushion, it is possible in turn to calculate the tensile force in the web. The curved blast face of the blast box can include a strip covering or a perforated covering.

Various configurations for determining the at least one strain property are possible.

For example, it can be determined between two consecutive driven rollers. In this case the two consecutive driven rollers are the two last rollers of the machine for producing a fibrous web, wherein the last roller can be the roller onto which the fibrous web is wound up. This configuration enables a particularly easy determination of the at least one strain property as the drive torque of the last drive is not influenced by any other tensile force, meaning the web draw can be deduced simply from the drive torques of the last two drives. It is then possible to determine the change of the elastic constant from the web draw changes and the differential speed.

In this case the local resolution in respect of the strain property of the web corresponds to the spatial distance between the two driven rollers.

Another configuration provides for the at least one strain property to be determined between three consecutive driven rollers. In this configuration it is possible to calculate the strain property at any position on the machine, meaning also prior to rewinding, in order to be able to make use of the results thus obtained not only for feedforward control but also for the corresponding further influencing of the fibrous web in the downstream process steps.

Determining the at least one strain property between three consecutive driven rollers makes sense at all positions of the machine for the production of a fibrous web where more driven rollers follow in the web running direction.

If the web is a machine covering circulating in a closed loop, then a strain property of the covering can be determined by way of the previous configuration.

In this connection it is possible for the at least one strain property to be determined with account taken of the time-related change of drive torque of the middle roller of the three driven rollers.

In the configuration with three consecutive driven rollers, changes of the strain property of the web always arise upstream from the middle roller of the rollers, meaning between the first roller and the middle roller, before this change takes effect after a certain transport time downstream from the middle roller, meaning between the middle roller and the last roller.

The drive torque applied by the middle roller, for example in order to maintain a preselected constant differential speed, is always influenced by the properties of the web upstream and downstream from the middle roller, hence it makes sense in this connection for the at least one strain property to be determined with account taken of the integral of the drive torque of the middle roller of the three driven rollers, wherein integration is performed as a function of time.

In this case integration is performed as a function of the time which is required by a location on the web to move from the first driven roller to the third driven roller. In this case the local resolution in respect of the strain property of the web corresponds to the spatial distance between the first and the last of the three driven rollers.

The strain property can be the elasticity of the web.

According to another embodiment of the present invention, it is possible for at least one strength property of the web to be calculated from the calculated strain property of the web. In this case the actual value of at least one controlled variable in the production process of the web with an influence on the strength property is determined and the strength property calculated by way of a model which creates a dependency of the strength property on the strain property and on the controlled variable. It is also possible to use a parameter instead of the controlled variable. In this case the model can take account in addition of the type of web and/or specific characteristics of the production process used and/or the design of the machine producing the web. Furthermore, the model can take account of values of the at least one strength property measured in the laboratory. In this case the model can include in particular a mathematical algorithm such as PCA, PLSR, SOM or fuzzy for example, or it can include a neuronal network.

With regard to the concrete embodiment of a sensor system by way of which the previously described process steps can be performed, attention is drawn to the European patent application with the publication number EP 1 517 207 A2, which herewith is included in full in this application.

The at least one strength property of the fibrous web includes the bursting strength, the longitudinal and/or transverse elongation at break, the tensile strength or the breaking length of the fibrous web.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows, in a schematic representation, a subsection of a machine for producing a fibrous web which is suitable for performing an embodiment of the method of the present invention;

FIG. 2 shows, in a schematic representation, a subsection of a machine for producing a fibrous web which is suitable for performing a second embodiment of the method of the present invention; and

FIG. 3 shows, in a schematic representation, a subsection of a machine for producing a fibrous web which is suitable for performing a third embodiment of the method of the present invention.

Corresponding reference characters indicate corresponding parts throughout the several views. The exemplifications set out herein illustrate embodiments of the invention, in one form, and such exemplifications are not to be construed as limiting the scope of the invention in any manner.

### DETAILED DESCRIPTION OF THE INVENTION

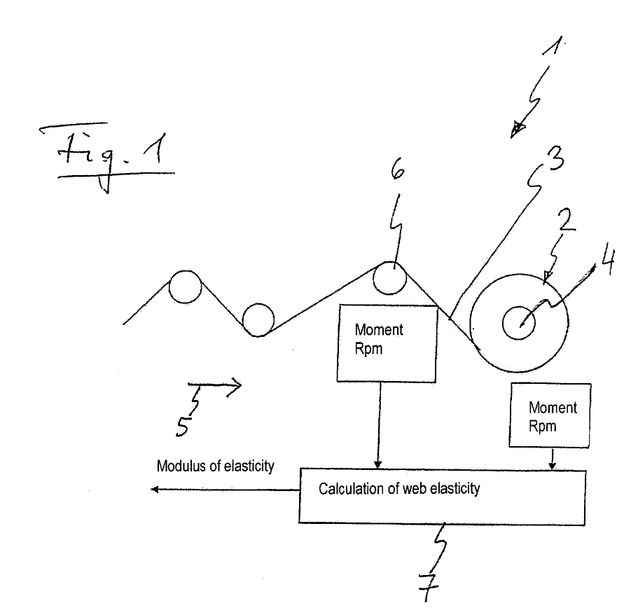

Referring now to the drawings, and more particularly to FIG. 1, there is shown a subsection of a machine 1 for producing a fibrous web 3, having a winding up apparatus 2 with which the fibrous web 3 is wound up onto a driven roller 4. The roller 4 represents the last roller of the machine 1. Arranged upstream from the last roller 4 in the web running direction 5 (arrow) is another driven roller 6 which can be formed, for example, by the last roller of a drying section of the machine 1. The fibrous web 3 is conveyed, unsupported, between the two driven rollers 4 and 6.

To determine, for example, the elasticity of the fibrous web 3 prior to winding up, the tensile force in the fibrous web 3 between the two consecutive rollers 6 and 4 is held constant at a predefined value such that the drive torques, and hence the power input of the two driven rollers 4 and 6, are not subject to any time-related change. Furthermore, the time-related change of the respective differential speed, meaning the difference in rpm between the two rollers 4 and 6, is determined by sensors (not illustrated). Because the differential speed is a yardstick for the strain of the fibrous web 3, it can be used to derive the elastic modulus of the section of fibrous web 3 which is being conveyed between the two driven rollers 4 and 6.

Accordingly, data concerning the rpm and the drive torque of each of the two driven rollers 4 and 6 are read out and fed to a computer 7 which calculates the elastic modulus of the fibrous web 3 from said data.

Account can also be taken of, inter alia, the values of friction between the fibrous web 3 and the driven rollers 4, 6 as well as other key data of the rollers 4 and 6 and their gear units, for example the roller diameters, thus enabling the differential speed to be derived directly from the rpm of the roller axes by way of a corresponding model for example.

By tracking the time-related change of the differential speed it is thus possible to track a change of elasticity of the fibrous web 3 which is continuously produced and wound up onto the winding apparatus 2. Hence it is possible, for example, to detect drifting of the fibrous web production process, which is notable in a change of elasticity of the fibrous web 3, during the actual production process, thus enabling suitable countermeasures based thereon to be introduced by influencing corresponding controlled parameters.

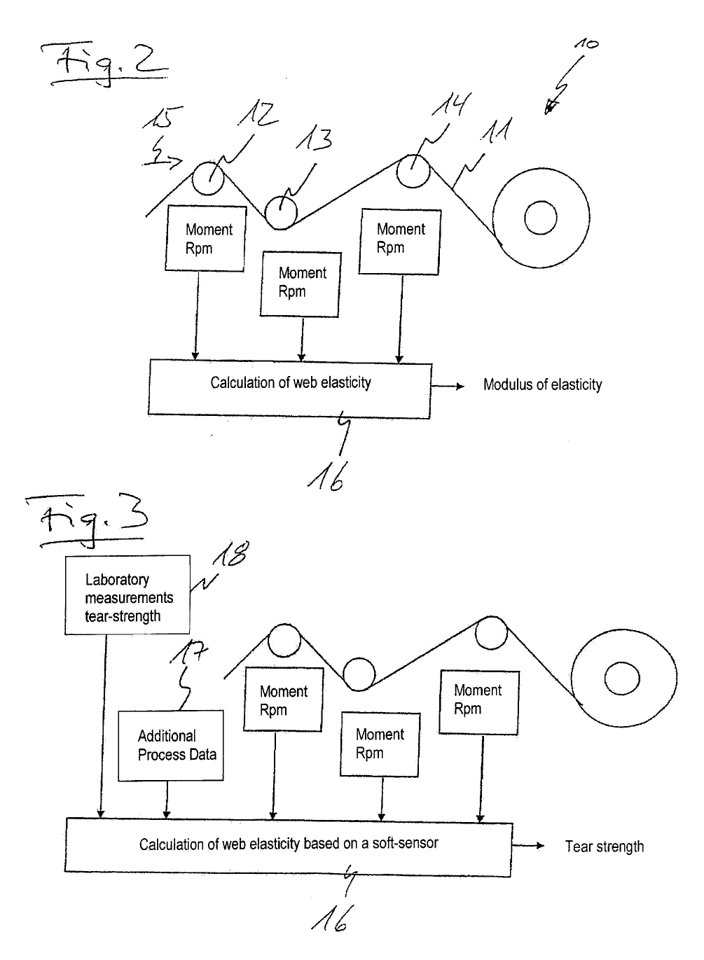

FIG. 2 shows a subsection of a machine 10 for producing a fibrous web 11. The subsection can be a region in the drying section of the machine 10 for example.

The subsection has three consecutive driven rollers 12, 13 and 14, via which the fibrous web 11 is conveyed in the web running direction 15 (arrow) and between which the fibrous web 11 is respectively conveyed unsupported.

In the region of the drying section the differential speed between the consecutive driven rollers 12 and 13 and the differential speed between the consecutive driven rollers 13 and 14 is held constant respectively at a fixed value, whereas the tensile force acting on the fibrous web 11 is controlled accordingly between the rollers 13 and 14 in order to maintain the respectively preselected differential speed.

In the example in question the elasticity of the fibrous web 11 is not determined at the end of the machine 10 but sooner, hence it is calculated by calculating the time-related constant differential speeds and the tensile force in the fibrous web 11 between the consecutive rollers 12 and 13 as well as the tensile force in the fibrous web 11 between the consecutive rollers 13 and 14. The values are fed to a computer 16 which calculates the elastic modulus of the fibrous web 11 from said values.

Alternatively, the elastic modulus can be determined on the basis of additional considerations. For instance, a change of elasticity of the fibrous web 11 always occurs upstream from the middle roller 13 before said change takes effect after a certain transport time downstream from the middle roller 13, meaning between the middle roller 13 and the last roller 14. Hence the elasticity of the fibrous web 11 upstream and downstream from the middle roller 13 is always a factor in the drive torque provided by the middle roller 13. In other words, the drive torque of the middle roller can be regarded as a yardstick for the web draw upstream and downstream from the middle roller 13.

For example, when a section of the fibrous web 11 with lower elasticity is situated between the first roller 12 and the middle roller 13, then the middle roller 13 has to apply a smaller drive torque than usual to provide the constant preselected differential speed because it is immediately drawn by the downstream roller 14 and because it itself has to apply less draw due to the lower elasticity of the web section. This is notable, for example, in a lower power input of the middle roller 13.

When the section with lower elasticity is then situated between the middle roller 13 and the following driven roller 14 on account of the fibrous web 11 being transported further, then the middle roller 13 has to apply a higher drive torque than usual to provide the constant preselected differential speed because it is less drawn by the downstream roller 14 on account of the lower elasticity and because it itself has to apply more draw due to the now higher elasticity of the web section between the first two rollers 12 and 13.

If the integral of the drive torque of the middle driven roller 13 is formed as a function of time, wherein integration is performed as a function of the time which is required by a location on the fibrous web 11 to move from the first roller 12 to the third driven roller 14, then the elastic modulus of the fibrous web 11 can be calculated from the integral as a function of the drive torque or as a function of the power input. The local resolution in respect of the elasticity of the fibrous web 11 corresponds in this case to the spatial distance between the first roller and the last driven roller 14.

FIG. 3 shows another embodiment of the present invention which corresponds to that of FIG. 2, with the addition that the breaking length of the fibrous web 11 is calculated from the calculated elasticity of the fibrous web 11. For this purpose the controlled variables influencing the breaking length are determined on the basis of process data which are provided to the computer 16 by a reading out unit 17. The computer 16 determines the breaking length by way of a model which creates a dependency of the breaking length of the fibrous web 11 on the elasticity and on the controlled variables, wherein values of the breaking length measured in the laboratory 18 and values of the controlled values established during production of the samples measured in the laboratory 18 are also taken into account in this case.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 Machine
2 Winding up apparatus
3 Fibrous web
4 Roller
5 Web running direction (arrow)
6 Roller
7 Computer
10 Machine
11 Fibrous web
12 Roller
13 Roller
14 Roller
15 Web running direction (arrow)
16 Computer
17 Reading out unit
18 Laboratory

What is claimed is:

1. A method for determining at least one strain property of a web running on a machine for the production of a fibrous web, said method comprising the steps of:
conveying the web via at least two consecutive driven rollers, wherein the web between the at least two consecutive driven rollers is unsupported respectively at least in a plurality of sections;
determining a tensile force in the web between said at least two consecutive driven rollers;
determining a differential speed of said at least two consecutive driven rollers in relation to each other; and
determining the at least one strain property of the web conveyed between said at least two consecutive driven rollers, dependent upon said at least one differential speed and said at least one tensile force.

2. The method according to claim 1, further comprising determining a different strain property of the web in a web running direction, dependent upon at least one of a time-related change of said tensile force and a time-related change of said differential speed.

3. The method according to claim 1, further comprising determining a different strain property of the web in a web running direction by calculating a time-related change of a respective said tensile force and holding constant over time said differential speed between said at least two consecutive rollers.

4. The method according to claim 1, further comprising determining a different strain property of the web in a web running direction by calculating a time-related change of a respective said differential speed and holding constant over time said tensile force of the web between said at least two consecutive rollers.

5. The method according to claim 1, wherein the web is a fibrous web comprising one of a paper web, a paperboard web, and a tissue web.

6. The method according to claim 1, wherein the web is a covering comprising one of a forming mesh, a press felt, a dryer fabric, and a smooth transfer belt.

7. The method according to claim 1, wherein said tensile force of the web is calculated, dependent upon a respective plurality of drive torques of a plurality of roller drives.

8. The method according to claim 7, wherein said plurality of drive torques are calculated from a plurality of values of a plurality of drive parameters of a plurality of roller drives, said plurality of drive parameters including one of an electric voltage, an electric current, and a power input.

9. The method according to claim 8, wherein said tensile force of the web is calculated, dependent upon a key data of at least one of a plurality of gear units of said plurality of roller drives and said at least two consecutive driven rollers, said key data including a frictional resistance of a bearing arrangement of said at least two consecutive driven rollers.

10. The method according to claim 9, wherein said step of determining the at least one strain property of the web is dependent upon a plurality of friction values between the web and said at least two consecutive driven rollers.

11. The method according to claim 1, wherein arranged between said at least two consecutive driven rollers is at least one non-driven roller via which the web is conveyed.

12. The method according to claim 1, wherein said at least one strain property is determined between two said consecutive driven rollers.

13. The method according to claim 12, wherein said two consecutive driven rollers are a last two said consecutive driven rollers of the machine for producing the fibrous web.

14. The method according to claim 13, wherein a last roller of said last two consecutive rollers is a roller onto which the web is wound up.

15. The method according to claim 1, wherein said at least one strain property is determined between three said consecutive driven rollers.

16. The method according to claim 15, wherein said at least one strain property is determined from a time-related change of a drive torque of a middle roller of said three consecutive driven rollers.

17. The method according to claim 15, wherein said at least one strain property is determined by integrating said drive torque of said middle roller of said three consecutive driven rollers as a function of time.

18. The method according to claim 17, wherein said integrating is performed as a function of a time which is required by a location on the web to move from a first driven roller to a third driven roller.

19. The method according to claim 1, wherein said strain property is an elasticity.

20. The method according to claim 1, further comprising calculating at least one strength property of the fibrous web from a calculated said strain property of the fibrous web.

21. The method according to claim 20, wherein said strength property is influenced by at least one controlled variable, said at least one controlled variable with said influence on said strength property determined and said strength property calculated dependent on said strain property and on said controlled variable.

22. The method according to claim 20, wherein said strength property is influenced by at least one parameter, said at least one parameter with said influence on said strength property determined and said strength property calculated dependent on said strain property and on said parameter.

23. The method according to claim 22, wherein said strength property is dependent on at least one of a type of the fibrous web, a plurality of specific characteristics of a production process used, and a design of the machine producing the fibrous web.

24. The method according to claim 23, wherein said strength property is dependent on a plurality of values of said at least one strength property measured in a laboratory.

25. The method according to claim 24, wherein said at least one strength property of the fibrous web comprises a bursting strength, at least one of a longitudinal and a transverse elongation at break, a tensile strength, and a breaking length.
